(19) United States
(12) Patent Application Publication
(10) Pub. No.: US 2014/0020927 A1
(43) Pub. Date: Jan. 23, 2014

(54) CABLE PROTECTOR LID CONNECTION SYSTEMS AND METHODS

(71) Applicants: Daniel Coffman, Northglenn, CO (US); Greg Widgery, Westminster, CO (US)

(72) Inventors: Daniel Coffman, Northglenn, CO (US); Greg Widgery, Westminster, CO (US)

(73) Assignee: CHECKERS INDUSTRIAL PRODUCTS, LLC, Broomfield, CO (US)

(21) Appl. No.: 13/552,494

(22) Filed: Jul. 18, 2012

(51) Int. Cl. H02G 3/04

(52) U.S. Cl. 174/97

(57) ABSTRACT

A cable protector includes a base member, at least one channel, and a lid. The at least one channel extends between opposing first and second ends of the base member and is structured to house at least one cable. The lid is mounted to the base member to cover the at least one channel and is releasably secured to the base member with at least one snap-fit connection.

### BACKGROUND

Over the years, various devices and apparatuses have been developed in an effort to protect hoses, cables, wiring, and the like from physical damage. In particular, numerous cable protector designs have been developed to protect cabling extending across walkways, roadways, and construction sites from physical damage caused by pedestrians, vehicular traffic, and other such external elements. Cable protectors have also proven useful in helping to minimize the risk of pedestrians tripping over such cabling.

Conventional cable protectors typically include a base portion have one or more channels extending in parallel between opposing ends of the cable protector to receive one or more cables. Side ramps may extend laterally outward from, or may be removably attachable to, the sides of the base portion of the cable protector to allow vehicles and the like to roll over the top of the cable protector. A lid may be pivotally attached to the base portion to provide access to the one or more channels. The lid is typically connected to the base portion along one side edge of the lid with a rod member (e.g., an axle rod) that extends through portions of the lid and portions of the base portion along a length of the base portion. An opposing or free edge of the lid rests upon an opposite side of the base portion.

In some applications, the free edge of the lid may inadvertently lift away from the base portion when a vehicle or other object moves over the cable protector. The lifted lid may expose the cabling, which is held in the channels, to undesirable environmental conditions and possible damage. The lifted lid may also pose a tripping hazard or be damaged itself if caught when partially opened.

Another challenge related to a lid that is connected to the base portion with a rod is that the cable protector typically must be disconnected from adjacent cable protectors in order for the rod to be removed to replace the lid. Disassembly of a cable protection system that includes multiple cable protectors assembled together with cabling extending through the assembly may be difficult depending on the specific set up.

A further challenge related to using a rod to connect the lid to the base portion of the cable protector is the possibility of the rod becoming damaged during use. The rod typically comprises fiberglass, rigid polymer or metal materials. The rod may be bent, fractured, or weakened in some way when the cable protector is used (e.g., when a heavy object such as a vehicle moves over the cable protector). The damaged rod may cause the lid to sit unevenly on top of the base portion or be released from the base portion, which may expose the cabling retained in the channels and create tripping/catching hazards that may result in harm to individuals, equipment, or the cable protector itself.

Opportunities exist for improvements in cable protector lids and related lid connection systems and methods.

### SUMMARY

One aspect of the present disclosure relates to a cable protector that includes a base member, at least one channel, and a lid. The at least one channel extends between opposing first and second ends of the base member and is structured to house at least one cable. The lid is mounted to the base member to cover the at least one channel and is releasably secured to the base member with at least one snap-fit connection.

The lid may include opposing first and second side edges, wherein the first side edge is pivotally connected to the base member with an axle that extends through a portion of the lid and a portion of the base member, and the second side edge is connected to the base member with the at least one snap-fit connection. The lid may include opposing first and second side edges, wherein the first side edge is connected to the base member with a first snap-fit connection, and the second side edge is connected to the base member with a second snap-fit connection. The lid may include opposing first and second side edges, wherein the first side edge is pivotally connected to the base member with the at least one snap-fit connection, and the second side edge rests upon the base member and is disconnected from the base member.

The at least one snap-fit connection may include at least one protrusion that releasably fits in at least one recess. The at least one protrusion may be carried by the lid and the at least one recess may be carried by the base member. The at least one protrusion and at least one recess may be arranged coaxially with each other along a side edge of the lid. The at least one protrusion may include a plurality of protrusions carried by a plurality of lid hinge members and the at least one recess may include a plurality of recesses carried by a plurality of base hinge members. The plurality of lid hinge members and the plurality of base hinge members may deflect to permit the plurality of protrusions to move into and out of the plurality of recesses. At least some of the base hinge members may include a recess in opposing end surfaces thereof, and at least some of the lid hinge members include a protrusion in opposing end surfaces thereof.

Another aspect of the present disclosure relates to a cable protector that includes a base member, at least one channel, first and second side ramps, a first connector, a first connector recess, and a lid. The base member includes first and second sides and first and second ends. The at least one channel extends between the first and second ends of the base member and is structured to receive at least one cable. The first side ramp extends from the first side of the base member and the second side ramp extends from the second side of the base member. The at least one first connector extends from the first end of the cable protector, and the at least one first connector recess is positioned at the second end of the cable protector. The lid is mounted to the base member and is movable between a closed position and an open position to control access to the at least one channel. The lid is secured to the base member with a snap-fit connection.

The snap-fit connection may provide a pivotal connection of the lid to the base member. The snap-fit connection may be releasable to provide disconnection of the lid from the base member. The lid may be pivotally connected to the base member with a hinge member that is separate from the snap-fit connection. The lid may include a plurality of protrusions and the base member may include a plurality of recesses receptive of the plurality of protrusions to provide the snap-fit connection.

A further aspect of the present disclosure relates to a method of assembling a cable protector. The method includes providing a cable protector having a base member and a lid, wherein the base member includes a plurality of channels sized to hold at least one cable. The method also includes connecting the lid to the base member with at least one releasable snap-fit connection, wherein the lid is pivotable relative to the base member to control access to the plurality of channels.

The lid may include a plurality of protrusions and the base member may include a plurality of recesses, and connecting the lid to the base member includes inserting the plurality of protrusions into the plurality of recesses to provide the at least one releasable snap-fit connection. The method may include pivotally connecting the lid to the base member with a removable axle along a first side edge of the lid, and the at least one releasable snap-fit connection is provided along a second side edge of the lid. The at least one releasable snap-fit connection may provide a pivotal connection between the lid and the base member. The at least one releasable snap-fit connection may include at least a first releasable snap-fit connection along a first side edge of the lid and at least a second releasable second snap-fit connection along a second side edge of the lid.

Features from any of the above-mentioned embodiments may be used in combination with one another in accordance with the general principles described herein. These and other embodiments, features and advantages will be more fully understood upon reading the following detailed description in conjunction with the accompanying drawings and claims.

### BRIEF DESCRIPTION OF THE DRAWINGS

The accompanying drawings illustrate a number of exemplary embodiments and are a part of the specification. Together with the following description, these drawings demonstrate and explain various principles of the instant disclosure.

FIG. 1 is a perspective view of an example cable protector system including a plurality of cable protectors in accordance with the present disclosure.

FIG. 2 is another perspective view of the cable protector system of FIG. 1.

FIG. 3 is a perspective view of a first cable protector of the cable protector system of FIG. 1.

FIG. 3A is a close-up view of a portion of a lid of the cable protector of FIG. 3.

FIG. 3B is a cross-sectional view of the cable protector shown in FIG. 4 taken along cross-section indicators 3B-3B.

FIG. 4 is another perspective view of the cable protector of FIG. 3 with the lid in a closed position.

FIG. 5 is an exploded perspective view of the cable protector of FIG. 3.

FIG. 6 is a cross-sectional view of the cable protector of FIG. 4 taken along cross-section indicators 6-6.

FIG. 7 is a cross-sectional view of the cable protector of FIG. 4 with the lid being connected to a base member.

FIG. 8 is a top view of the lid of the cable protector of FIG. 3.

FIG. 9 is a cross-sectional view of a base member of the cable protector of FIG. 5 taken along cross-section indicators 9-9.

FIG. 10 is a perspective view of a second cable protector of the cable protector system of FIG. 1.

FIG. 11 is a perspective view of the cable protector of FIG. 10 with a lid in a closed position.

FIG. 12 is an exploded perspective view of the cable protector of FIG. 10.

FIG. 13 is another exploded perspective view of the cable protector of FIG. 10.

FIG. 14 is a top view of the lid of the cable protector of FIG. 10.

FIG. 15 is a perspective view of a third cable protector of the cable protector system of FIG. 1.

FIG. 16 is a perspective view of the cable protector of FIG. 15 with a lid in a closed position.

FIG. 17 is an exploded perspective view of the cable protector of FIG. 15.

FIG. 18 is another exploded perspective view of the cable protector of FIG. 15.

FIG. 19 is a top view of the lid of the cable protector of FIG. 15.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, one of skill in the art will understand that the exemplary embodiments described herein are not intended to be limited to the particular forms disclosed. Rather, the instant disclosure covers all modifications, equivalents, and alternatives falling within the scope defined by the appended claims.

### DETAILED DESCRIPTION OF EXEMPLARY EMBODIMENTS

As will be described in greater detail below, the present disclosure generally relates to cable protectors and cable protector systems. Cable protector systems may include a plurality of cable protectors and other features such as ramps, corner pieces, handrails, etc., that are connected together. Various components of the cable protector system may be connected together with one or more connectors. The cable protectors may include lids that provide access to channels within the cable protector that hold hoses, cables, wiring, and the like.

One aspect of the present disclosure relates to a cable protector lid connection system and related methods of connecting a lid to a cable protector. The lid may be connected to a base member of the cable protector with a pivot connection. At least a portion of the lid may be connected to the base member with a snap-fit connection, interference fit, or other releasable, positive connection. The snap-fit connection may be a releasable connection that permits disconnection of a portion of the lid from the base member while still providing positive attachment. The snap-fit connection may be referred to as a releasable connection or a releasable pivot connection.

The snap-fit connection may provide the sole means of connecting the lid to the base member or other portion of the cable protector. In other examples, the snap-fit connection may be a secondary connection feature. For example, one side edge of the lid may be pivotally connected to the base member using an axle rod that passes through portions of the lid and portions of the base member. An opposing side edge of the lid may be releasably connected to the base member with a snap-fit connection. In other examples, both side edges of the lid are releasably connected to the base member (or other portions of the cable protector such as a side ramp) with a snap-fit connection.

The snap-fit connection may include at least one protrusion arranged to fit within a mating recess, such as a bore or channel. The protrusion and mating recess may be carried by the lid, the base member or other portion of the cable protector (e.g., a side ramp). In one example, the lid carries a plurality of protrusions and the base member carries a plurality of mating recesses that receive the protrusions. In one example, the protrusions have a contoured shape such as, for example, a hemispherical shape. The mating recesses may have any desired shape including, for example, a cylindrical shape with circular cross-section or a concave shape. All of the protrusions along one side edge of the lid and all of the recesses on the base member that receive the protrusions may be aligned in a coaxial arrangement when the lid is assembled with the base member. In at least some arrangements, the snap-fit connection may provide relative pivoting between the lid and the base member. In other examples, the snap-fit connection provides a releasable connection between the lid and base member that resists movements in all directions of motion (e.g., pivoting or rotation).

The snap-fit connection features of the cable protector may be integrally formed with respective features of the cable protector that carry the snap-fit connection features. For example, the protrusions carried by the lid may be integrally formed as a single piece with the remaining portions of the lid such as, for example, hinge members that extend laterally from a side edge of the lid. In other examples, the snap-fit connection features may be separately formed and mounted to the cable protector member that carries the snap-fit connection features (e.g., the lid or base member) in a separate assembly step.

The snap-fit connection features disclosed herein may provide a positive attachment of at least one side edge of the lid to the remaining structure of the cable protector (e.g., the base member). This positive attachment may help maintain the lid in a closed position when the cable protector is in use, such as when a vehicle drives over the cable protector. Maintaining the lid in a closed position may reduce the risk of a person or equipment catching on the lid, which may cause injury for the person or damage to the equipment or the cable protector. In embodiments in which the snap-fit connection features provide a pivotal connection of the lid to the base member that replaces the axle member, the snap-fit connection features may have greater flexibility and resilience during use of the cable protector.

Furthermore, the snap-fit connection features may make it possible to more easily replace the lid if the lid is damaged or if a different type of lid is needed for a given application. A lid may be replaced while the cable protector is attached to adjacent cable protectors. As discussed above, replacing the lid is typically not possible with other types of cable protectors wherein the axle member must be removed in order to remove the lid.

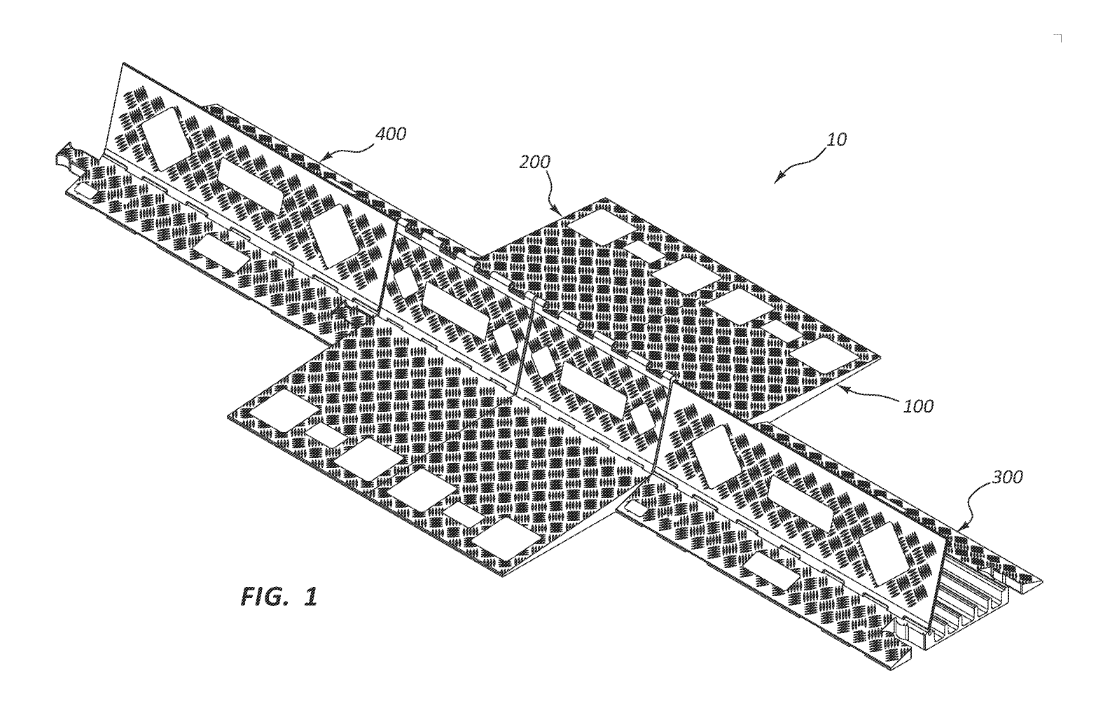

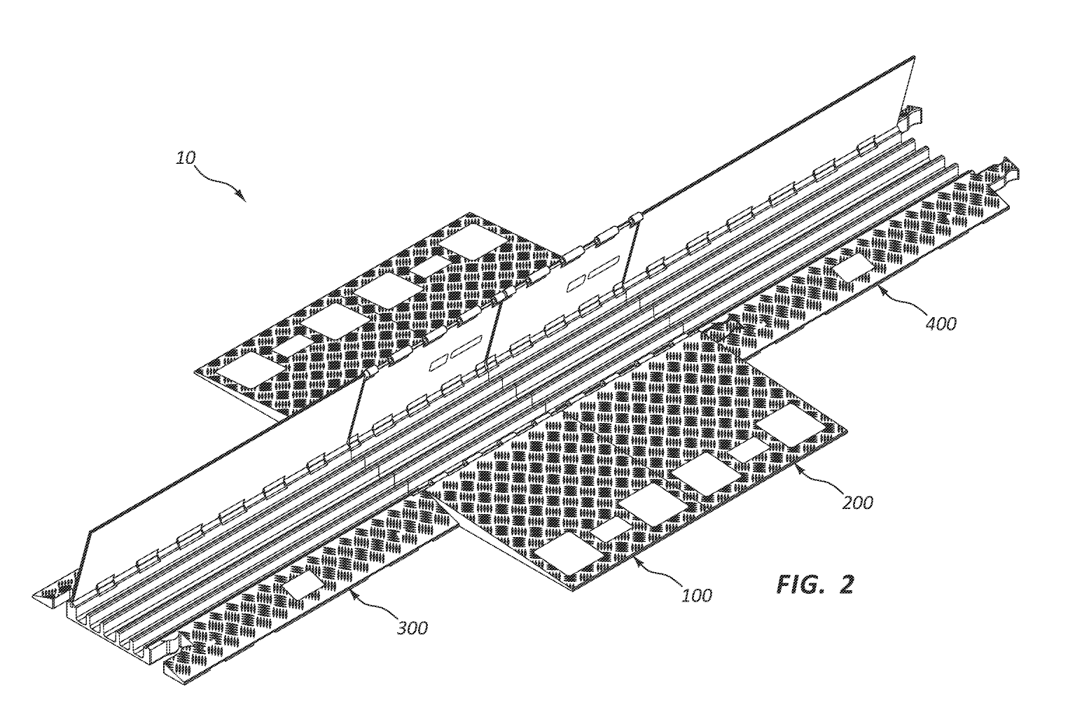

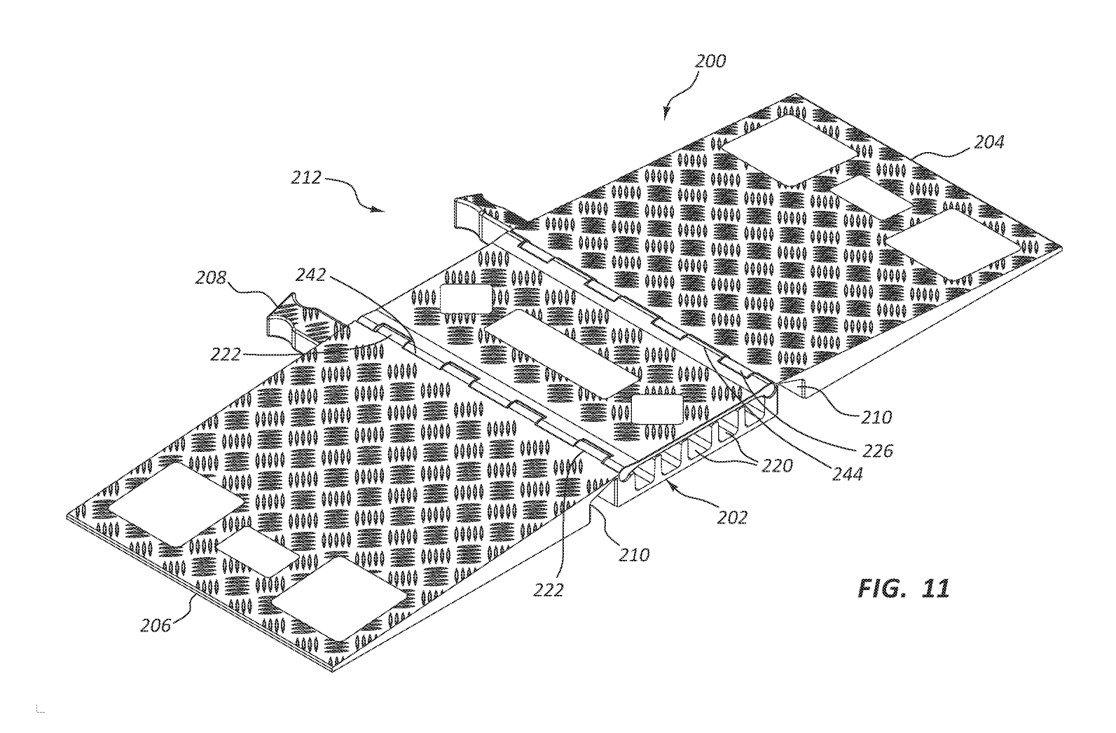

Referring now to FIGS. 1-19, several different types of cable protectors with various snap-fit connection arrangements are shown and described. FIGS. 1 and 2 show a cable protector system 10 including first, second, third and fourth cable protectors 100, 200, 300, 400. The cable protectors 100, 200, 300, 400 are connected together to provide at least one continuous channel that carries cabling. The cable protectors include lids that provide access to the channels and the cabling that is held in the channels. The first, second and third cable protectors 100, 200, 300 have different arrangements for the lid connection features. The fourth cable protector 400 includes the same lid connection features as the third cable protector 300.

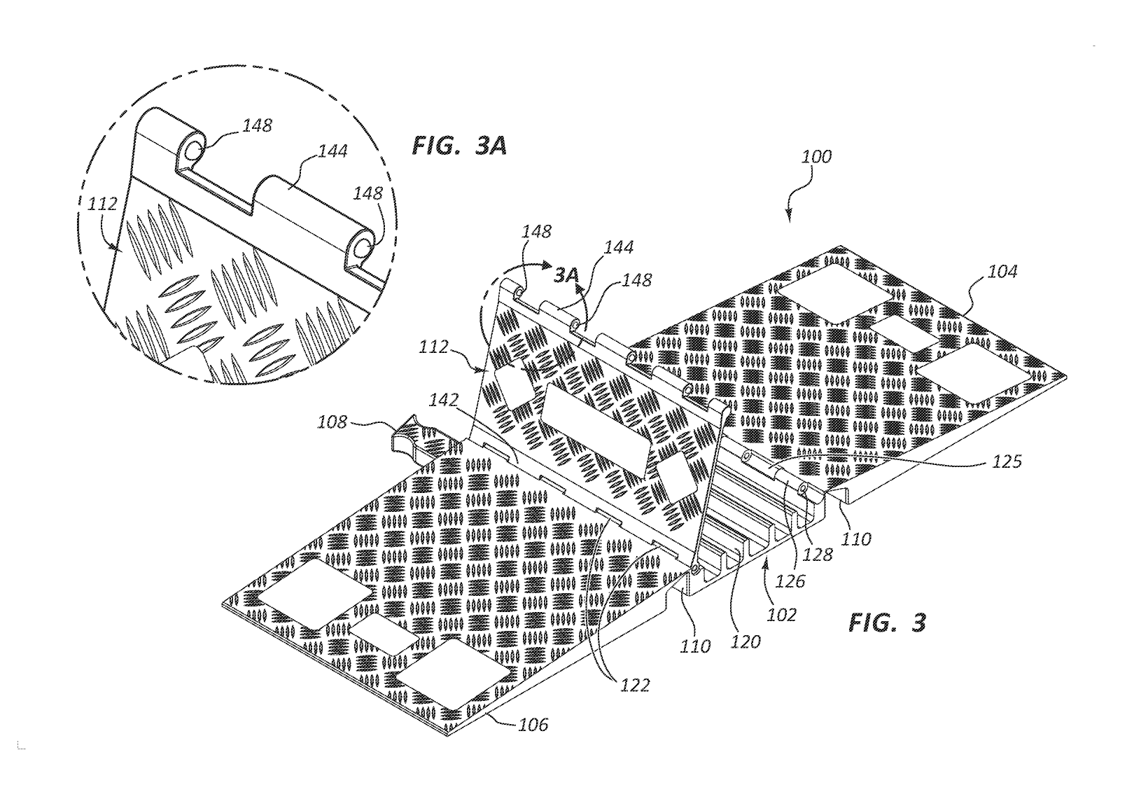

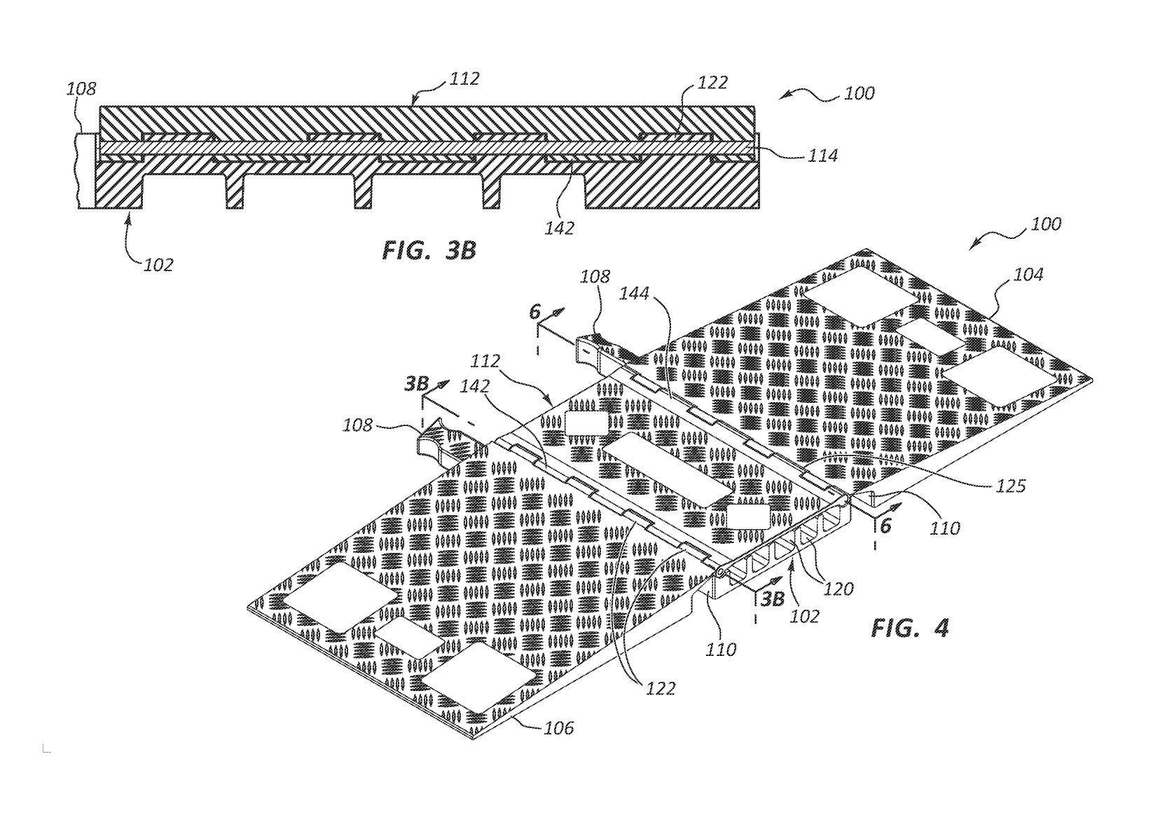

Referring to FIGS. 3-9, the cable protector 100 is shown including a base member 102, first and second side ramps 104, 106, a plurality of connectors 108, a plurality of connector recesses 110, a lid 112, and a hinge rod 114. The first and second side ramps 104, 106 extend along side edges of the base member 102. The connectors 108 extend from one end of the base member 102 and the connector recesses 110 are formed in an opposite end of the base member 102. The connectors 108 and connector recesses 110 are used to connect the cable protector 100 to adjacent cable protectors. The lid 112 is pivotally connected to the base member 102 along one side edge of the lid 112 with the hinge rod 114.

The base member 102 includes a plurality of channels 120, a set of first base hinge members 122 having a rod bore 123 extending therethrough, and a set of second base hinge members 126 that include a plurality of connection recesses 128. The second base hinge members 126 are spaced apart a distance L₁ (see FIG. 9). The connection recesses 128 have a diameter D₁. The connection recesses 128 may extend along the entire length L₁ (see FIG. 9). The first base hinge members 122 may have a similar spacing L₁. The gaps or spaces between the first base hinge members 122 and the gap or spacing between the second base hinge members 126 may be sized to receive mating hinge members of the lid 112. The base member 102 may include grooves 125 extending along the gap or space between the adjacent first base hinge members 122 and between the second base hinge members 126 that provide a pivot surface or bearing surface for the hinge members of the lid 112.

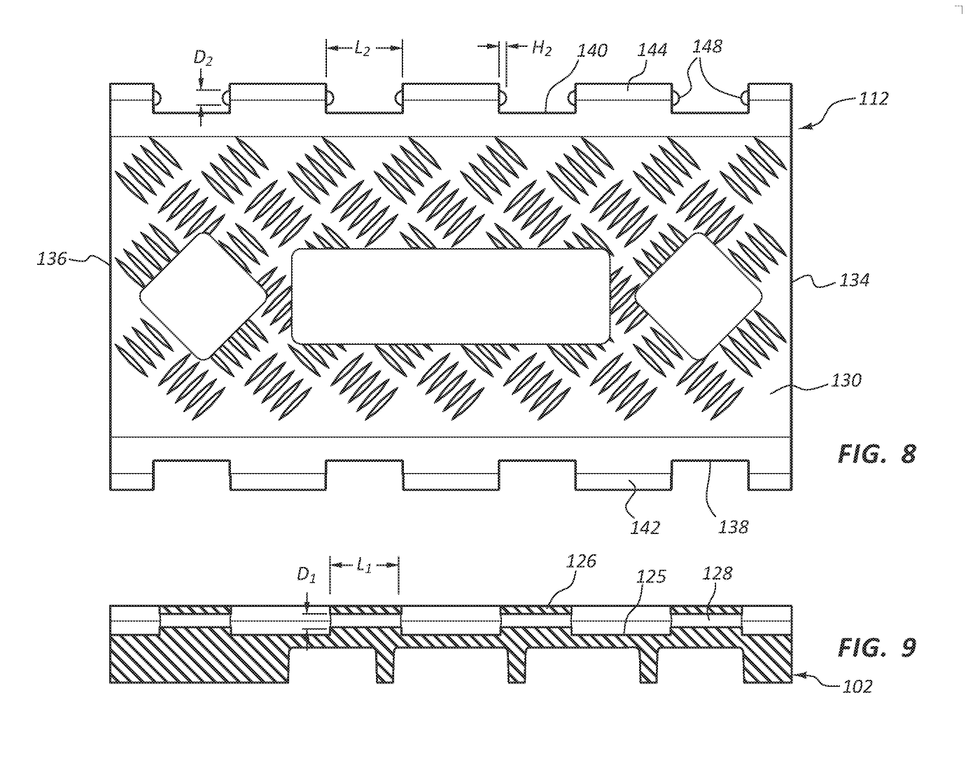

FIG. 8 shows the lid 112 including top and bottom surfaces 130, 132 (see FIG. 7), first and second ends 134, 136, first and second side edges 138, 140, a set of first lid hinge members 142 having a lid rod bore 143 extending therethrough, and a set of second lid hinge members 144 having a plurality of connection protrusions 148 positioned thereon. The lid rod bore 143 is aligned with the rod bore 123 when the first lid hinge members 142 are positioned between the first base hinge members 122. The hinge rod 114 extends through the rod bore 123 and lid rod bore 143 to provide a hinge connection between the base member 102 and the lid 112. The hinge rod 114 provides a connection between the base member 102 and lid 112 that may be disconnected by removing the hinge rod 114 in a length direction (e.g., parallel to the channels 120). Access to hinge rod 114 is typically only possible when the cable protector 100 is disconnected from adjacent cable protectors that otherwise block access to the rod bore 123.

The second lid hinge members 144 may be spaced apart a distance L₂. The first lid hinge members 142 may also be spaced apart a distance L₂. The distance L₂ is typically less than the spacing L₁ so that the first and second lid hinge members 142, 144 may be inserted in the space between the first and second base hinge members 122, 126, respectively.

The connection protrusions 148 may have a diameter D₂ and a height H₂ (see FIG. 8). The diameter D₂ may be substantially the same as the diameter D₁, and the height H₂ may be no greater than the depth H₁. In at least some arrangements, the diameter D₂ is less than the diameter D₁ to provide easier insertion of the connection protrusions 148 into the connection recesses 128.

While the connection protrusions 148 are shown as hemispherical structures, the connection protrusions 148 may have different shapes in other embodiments. For example, the connection protrusions 148 may have a cylindrical shape with a circular cross-section. Other shapes include, for example, pyramid, conical, and cubical shapes. The connection recesses may have a shape that mirrors the shape of the connection protrusions.

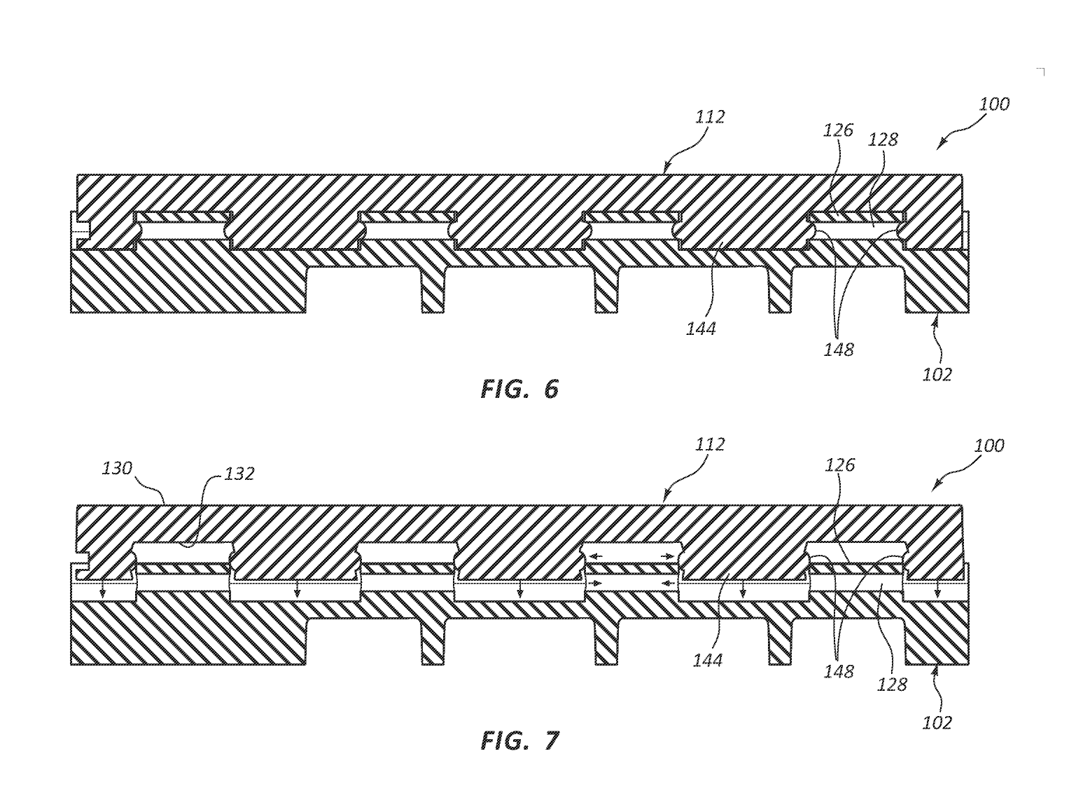

The connection protrusions 148 are shown in FIG. 8 aligned in parallel and coaxial with each other. The connection protrusions 148 are arranged coaxial with the connection recesses 128 when the lid 112 is mounted to the base member 102 as shown in at least FIG. 6. This coaxial arrangement of the connection recesses 128 with the connection protrusions 148 may make it possible for the lid 112 to pivot about the connection recesses 128 and connection protrusions 148 (e.g., if the hinge rod 114 is removed from the cable protector 100).

Positioning the connection protrusions 148 within the connection recesses 128 may provide a snap-fit connection between the lid 112 and the base member 102. A snap-fit connection is a connection in which the connecting features deform, flex or move in order for the connection to be made. Typically, the features that deform, flex or move return to a position that limits disconnection, at least not without application of a significant force (e.g., a force greater than forces normally applied to the features during use).

FIG. 7 is a cross-sectional view of the cable protector 100 showing potential deflection, deformation, or movement of various features of the base member 102 and the lid 112 in order for the connection protrusions 148 to fit within the connection recesses 128. FIG. 7 shows that the connection protrusions 148, material surrounding the connection recesses 128, and portions of the second base hinge members 126 and second lid hinge members 144 may deform, flex, or move as the connection protrusions 148 move into the connection recesses 128. Similar types of deflection, deformation, or movement may occur to permit disconnection of the lid 112 from the base member 102.

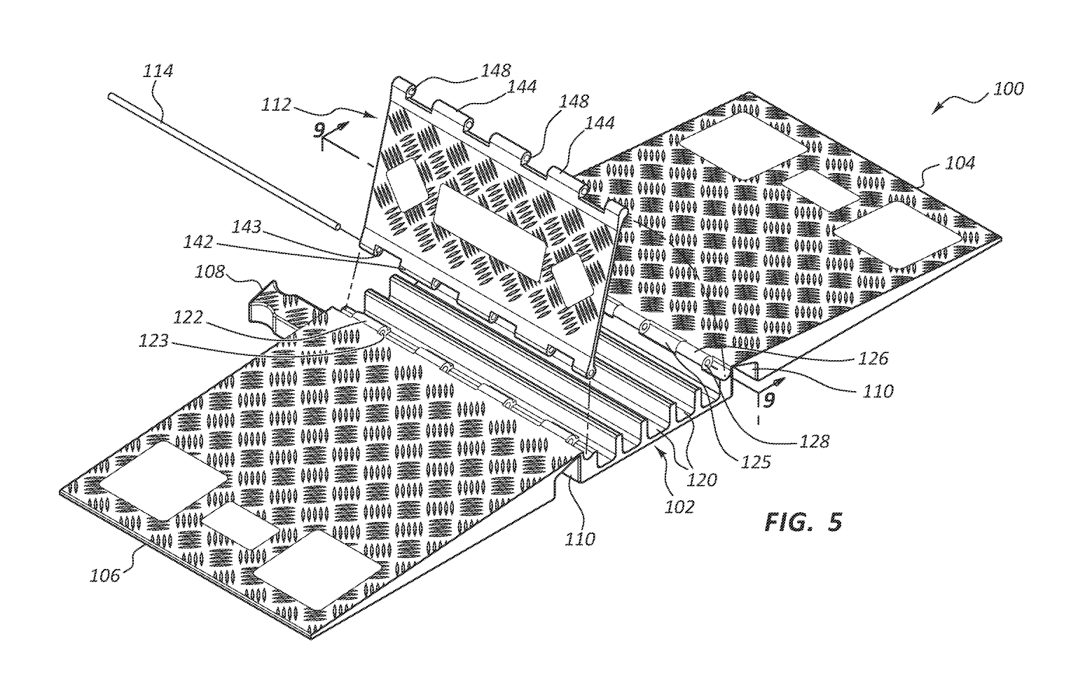

When the lid 112 is connected to the base member 102 with the hinge rod 114 as shown in FIG. 3, the lid 112 may rotate from the open position of FIG. 3 into the closed position of FIG. 4 by applying a rotation force to the lid 112. The rotation may move the connection protrusions 148 into the connection recesses 128 to provide a snap-fit connection. Once the lid 112 is in the closed position of FIG. 4, the hinge rod 114 may be removed and the lid 112 rotated into the open position in an opposite direction with the first side edge 138 being moved out of contact with the base member 102. The lid 112 may rotate about a hinge arrangement provided by the interface between connection protrusions 148 and connection recesses 128. The second lid hinge members 144, the second base hinge members 126, and the gaps or spaces therebetween may be configured to promote rotation of the lid 112 relative to the base member 102.

The connection protrusions 148 may be positioned on some or all of the second lid hinge members 144. The connection recesses 128 may be positioned on the second base hinge members 126 only at locations where a mating connection protrusion 148 is positioned. Any desired arrangement is possible for the numbers and positions of the connection recesses 128, connection protrusions 148, the second base hinge members 126 and the second lid hinge members 144.

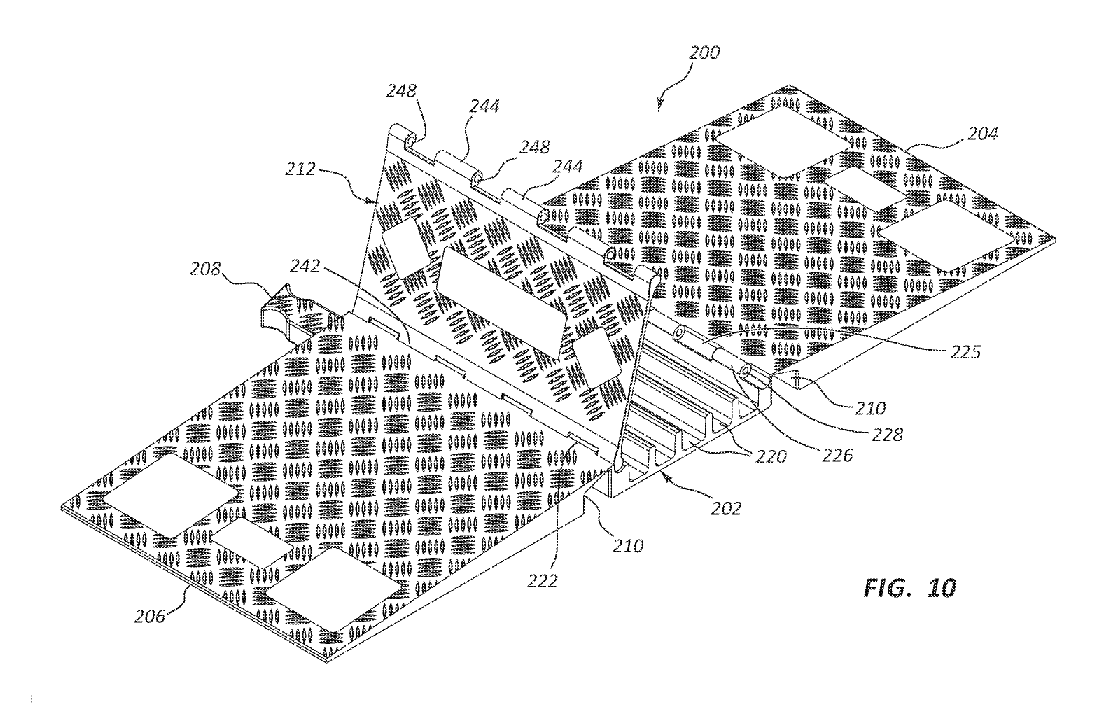

Referring now to FIGS. 10-14, the second cable protector 200 is shown including lid connection features along the first and second side edges of the lid. The connection features may include snap-fit connection features on each of the opposing side edges of the lid.

The cable protector 200 includes a base member 202, first and second side ramps 204, 206, connectors 208, connector recesses 210, and a lid 212. The base member 202 may include a plurality of channels 220, a set of first base hinge members 222 having a plurality of connectors recesses 223, and a set of second base hinge members 226 having a plurality of connection recesses 228. The base member 202 may include grooves 225 extending along the gap or space between the adjacent first base hinge members 222 and between the second base hinge members 226 that provide a pivot surface or bearing surface for the hinge members of the lid 212.

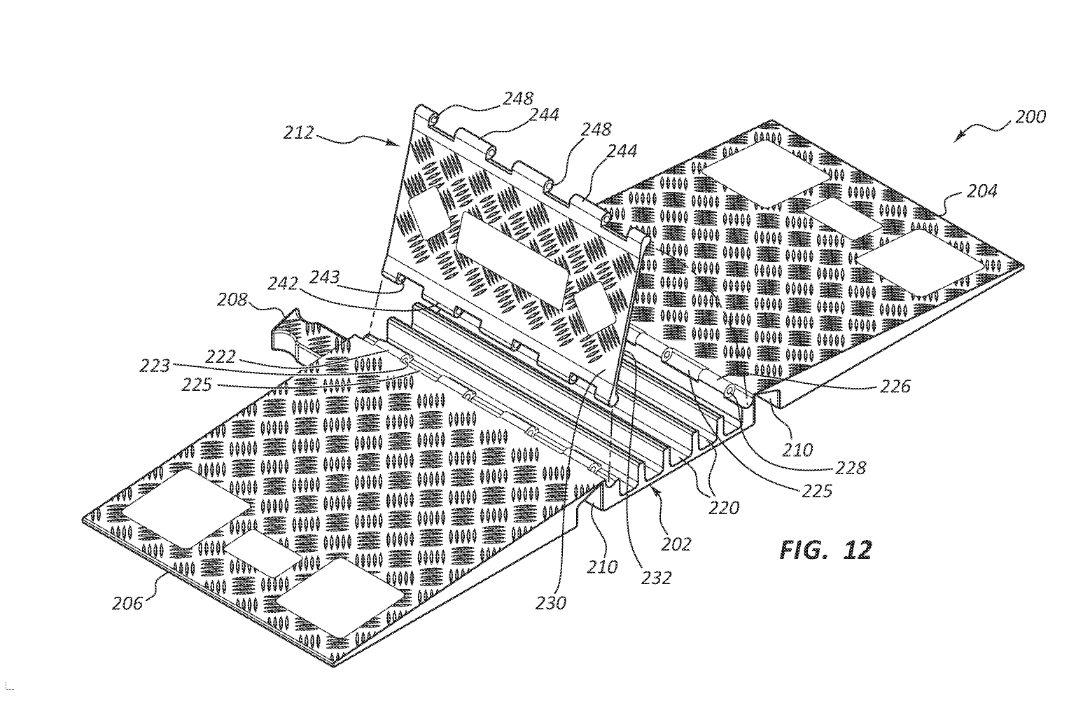

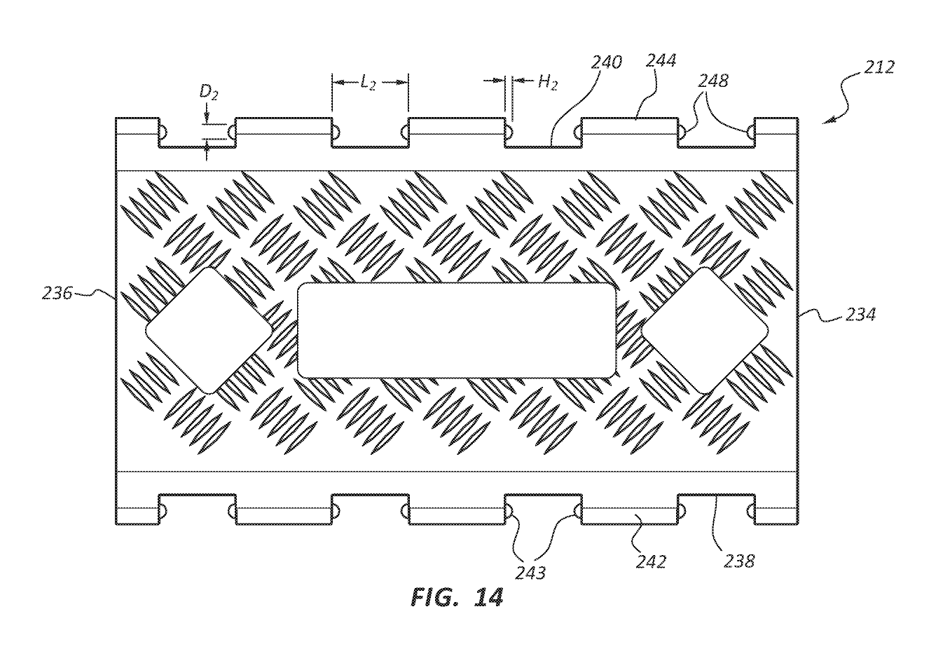

FIG. 14 shows the lid 212 including top and bottom surfaces 230, 232 (see FIG. 12), first and second ends 234, 236, first and second side edges 238, 240, a set of first lid hinge members 242 having a plurality of connection protrusions 243, and a set of second lid hinge members 244 having a plurality of connection protrusions 248. The first lid hinge members 242 may be positioned between the first base hinge members 222. The second lid hinge members 244 may be positioned between the second base hinge members 226. The first connection protrusions 243 may fit into the first connection recesses 223 to provide a snap-fit connection between the first side edge 238 of the lid 212 and the base member 202. The second connection protrusions 248 may fit into the second connection recesses 228 to provide a snap-fit connection between the second side edge 240 of the lid 212 and the base member 202.

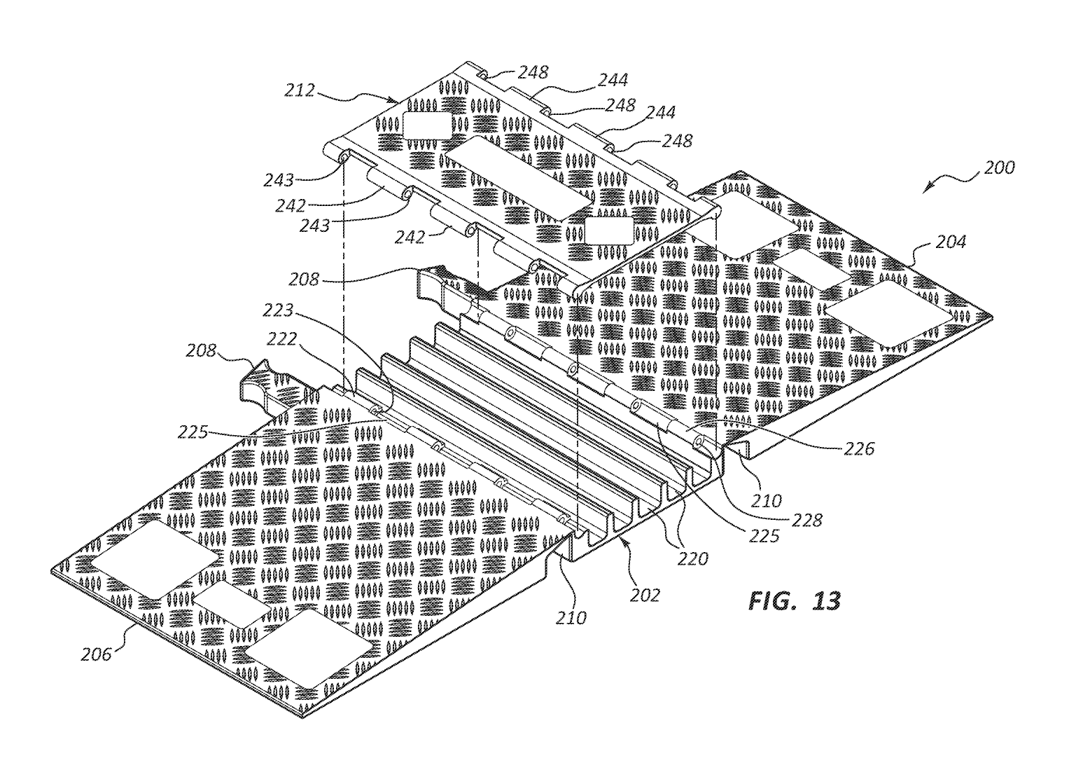

The snap-fit connection along the first side edge 238 may provide a pivotal connection of the lid 212 to the base member 202. The snap-fit connection along the second side edge 240 may also provide a pivotal connection of the lid 212 to the base member 202. These pivotal connections may provide rotation of the lid 212 between open and closed positions in either opening direction for the lid 212. The snap-fit connections along the first and second side edges 238, 240 may be made in any desired sequence. For example, the lid 212 may be arranged as shown in FIG. 13 and both of the first and second snap-fit connections made be made at the same time by dropping the lid vertically into contact with the base member 202 to connect the first connection protrusions 243 with the first connection recesses 222 and the second connection protrusions 248 with the second connection recesses 228. The lid 212 may be removed in a similar way by disconnecting the first and second snap-fit connections concurrently. The lid 212 may also be removed from the base member 202 by disconnecting one of the snap-fit connections along one side edge of the lid followed by disconnecting the other snap-fit connection along the other side edge of the lid. The lid 212 may be disconnected from and connected to the base member 202 by arranging the lid 212 in any desired orientation such as in a generally vertical orientation as shown in FIG. 12.

Providing snap-fit connections on both of the side edges of the lid 212 may facilitate replacement of the lid 212 without having to disconnect the cable protector 200 from adjacent cable protectors. Further, the lid connection features of the cable protector 200 provide the option of opening the lid in either direction, mounting the lid 212 to the base member 202 with the lid in any of a variety of different orientations, and providing a versatile connection arrangement in which the first and second side edges 238, 240 may be connected to either of the first and second base hinge members 222, 226.

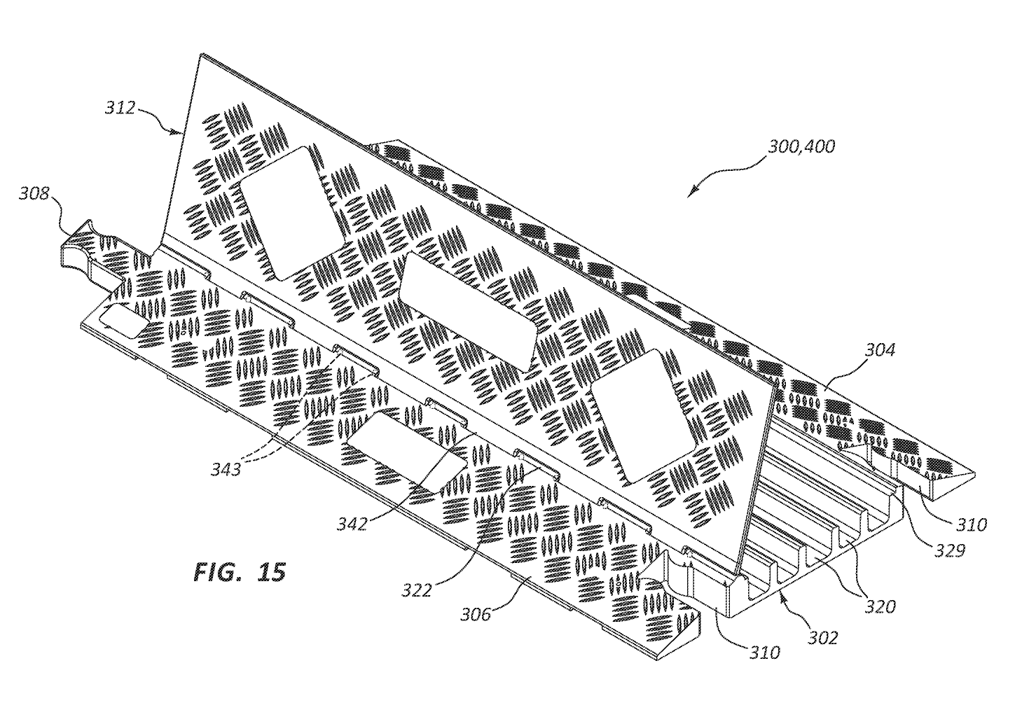

Referring now to FIGS. 15-19, the cable protectors 300, 400 are shown and described. The cable protectors 300, 400 include a base member 302, first and second side ramps 304, 306, connectors 308, connector recesses 310, and a lid 312. The base member 302 includes a plurality of channels 320, and a set of first base hinge members 322 comprising a plurality of connection recesses 323. The base member 302 may include grooves 325 extending along the gap or space between the adjacent first base hinge members 322 that provide a pivot surface or bearing surface for the hinge members of the lid 312.

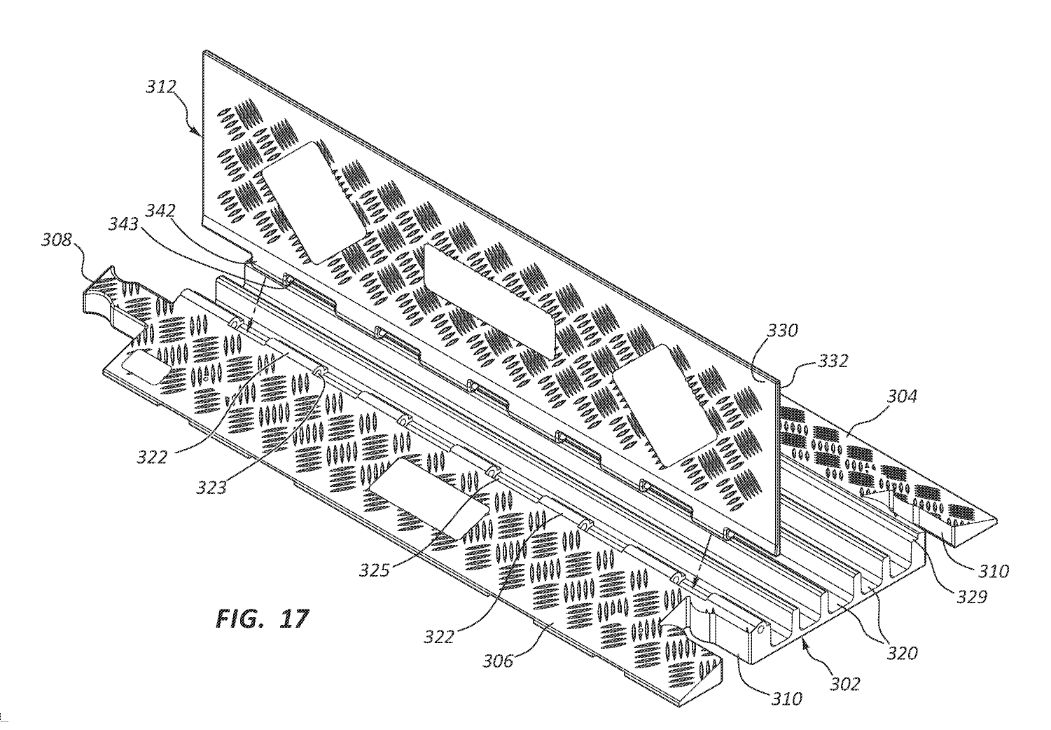

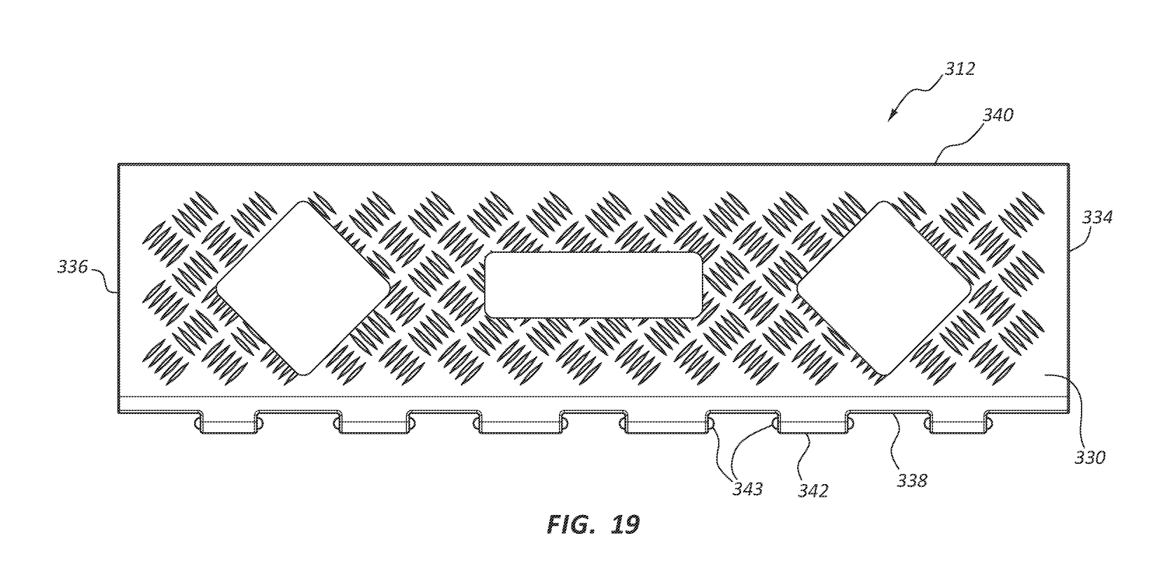

FIG. 19 shows the lid 312 including top and bottom surfaces 330, 332 (see FIG. 17), first and second ends 334, 336, first and second side edges 338, 340, and a set of first lid hinge members 342 including a plurality of connector protrusions 343.

The lid 312 is connected to the base member 302 by inserting the first lid hinge members 342 into the spaces between the first base hinge members 322 thereby inserting the connection protrusions 343 into the connection recesses 323. A connection between the lid 312 and the base member 302 may be a releaseable connection and may be referred to as a snap-fit connection or interference fit connection having properties similar to the connections described above with reference to cable protectors 100, 200. The connection features of the cable protectors 300, 400 may provide a releaseable, positive connection between the first side edge 338 and the base member 302.

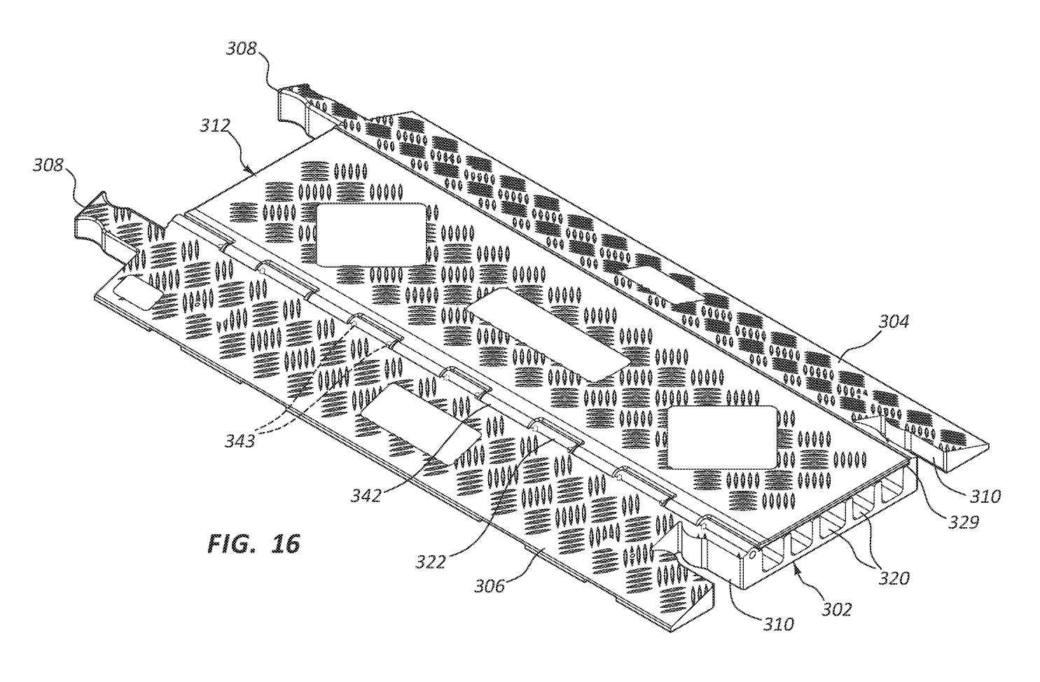

The second side edge 340 may rest upon a lid seat 329 when the lid 312 is in a closed position (see FIG. 16). The second side edge 340 may be free floating relative to the base member 302. The second side edge 340 may be unconnected relative to the base member 302.

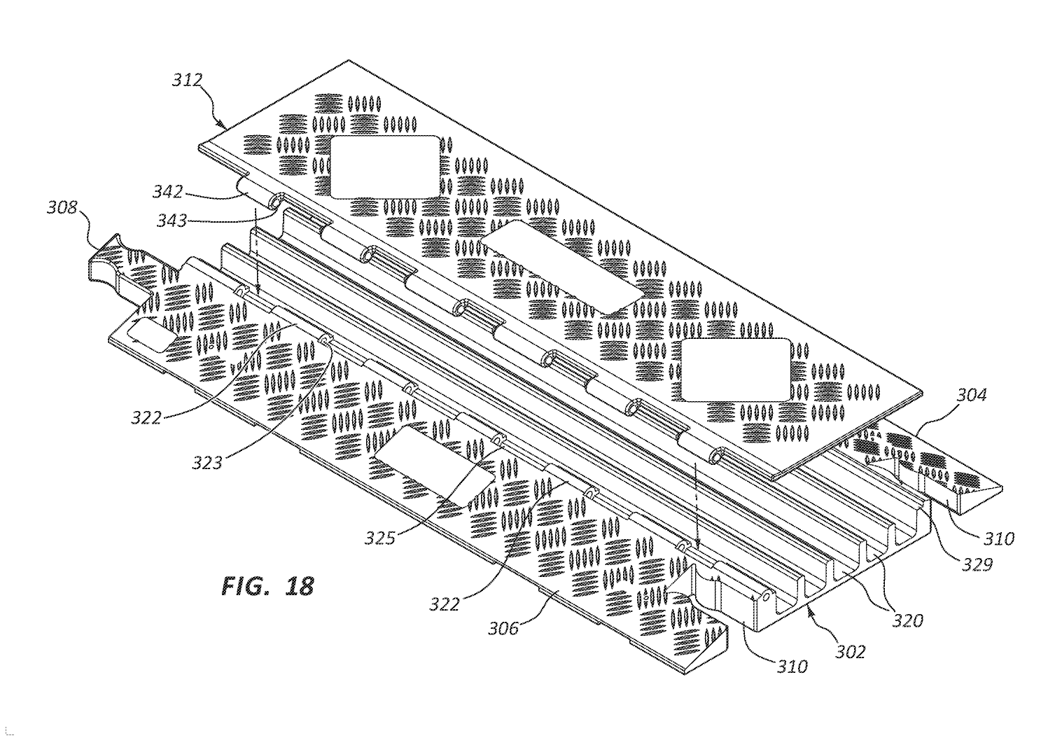

The snap-fit connection provided by the connection protrusions 343 within the connector recesses 323 may be released when the lid 312 is in any rotated position, such as the generally vertical position shown in FIG. 17 or the generally horizontal position shown in FIG. 18. The lid 312 may be disconnected from the base member 302 while the cable protectors 300, 400 are connected to adjacent cable protectors. The snap-fit connection of the cable protectors 300, 400 may have the same or similar advantages as discussed above related to the cable protectors 100, 200.

One possible advantage related to using the lid connection features disclosed herein is the ability to hold the lid of a cable protector in a closed position relative to the base member. The lid may be releasably held in the closed position using, for example, the snap-fit and interference fit connection features disclosed herein.

Another potential advantage related to the cable protectors disclosed herein is the ability to remove the lid of the cable protector using different methods than solely by removing a hinge rod that is used to connect the lid to the base member. For example, the lid may be removed from the cable protector while the cable protector is connected to a plurality of adjacent cable protectors. The lid may be removed vertically. The lid may be opened by rotating one side edge of the lid to disconnect the snap-fit connection on that side edge while an opposing side edge maintains a pivotal connection to the base member. In some arrangements, either side edge of the lid may be removably connected to or disconnected from the base member using a releasable connection feature such as the snap-fit connection features disclosed herein.

A further potential advantage relates to being able to hold the lid in a closed position with a positive, releasable connection, thereby reducing the possibility of the lid being damaged by being caught by users or equipment if the lid is inadvertently partially opened. Without the lid connection features disclosed herein, the lid may be partially opened due to significant forces being applied to the cable protector (e.g., when a vehicle drives over the cable protector) or if the hinge rods used to secure the lid to the base member become damaged during use. The various lid connection features disclosed herein may provide flexibility in a connection interface between the lid and the base member, which may provide some give or resiliency that helps return the lid to a closed position or maintain the lid in a closed position during use. The lid connection features may provide these benefits without the hinge features being damaged (e.g., permanently deformed or broken).

In some examples, the hinge features are built into the lid and comprise the same materials as the lid and base member. The lid and base member typically comprise a flexible, elastic, resilient material such as rubber or various types of polymer materials. These types of flexible, resilient, elastic materials may have a tendency to resist failure and permanent deformation as compared to other materials typically used for the hinge (e.g., a fiberglass or metal rod).

Another advantage of the lid connection features disclosed herein is the ability to hold the lid in a closed position without the use of external fasteners such as brackets, clips, locks, or the like. In at least some arrangements, the connection features of the present disclosure are integrally formed with the lid, base member, or other feature of the cable protector (e.g., side ramps). The integral formation of the lid connection features may have advantages as compared to other connection features that are externally mounted pieces.

While the several examples disclosed herein with reference to the figures include protrusions and recesses that are aligned coaxially, other types of connection features may be used in different arrangements. In one example, the protrusions carried by the lid may face laterally and the recesses in the base member also are oriented laterally relative to a length dimension of the lid. In this type of arrangement, the lid may provide a snap-fit or interference fit connection but not permit the lid to pivot relative to the base member about the interface between the protrusion and recess while maintaining positive connection of the lid to the base member.

The elements of the exemplary cable protector systems described herein and illustrated with reference to the attached figures, including the lid connection features, may be formed of any material or combination of materials. For example, the cable protectors and side ramps may be molded of a rigid, high-strength polymer material capable of withstanding repeated loadings and stresses. In addition, plastic plating or gripping may be formed on the upper surfaces of one or more of these elements to improve traction for pedestrians or vehicles traveling over the cable protector system.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the instant disclosure. The embodiments disclosed herein should be considered in all respects illustrative and not restrictive. Reference should be made to the appended claims and their equivalents in determining the scope of the instant disclosure.

Unless otherwise noted, the terms “a” or “an,” as used in the specification and claims, are to be construed as meaning “at least one of” In addition, for ease of use, the words “including” and “having,” as used in the specification and claims, are interchangeable with and have the same meaning as the word “comprising.”

What is claimed is:

1. A cable protector, comprising:
a base member;
at least one channel extending between opposing first and second ends of the base member and structured to house at least one cable;
a lid mounted to the base member to cover the at least one channel, the lid being releasably secured to the base member with at least one snap-fit connection.

2. The cable protector of claim 1, wherein the lid includes opposing first and second side edges, the first side edge being pivotally connected to the base member with an axle that extends through a portion of the lid and a portion of the base member, and the second side edge being connected to the base member with the at least one snap-fit connection.

3. The cable protector of claim 1, wherein the lid includes opposing first and second side edges, the first side edge being connected to the base member with a first snap-fit connection, and the second side edge being connected to the base member with a second snap-fit connection.

4. The cable protector of claim 1, wherein the lid includes opposing first and second side edges, the first side edge being pivotally connected to the base member with the at least one snap-fit connection, and the second side edge rests upon the base member and is disconnected from the base member.

5. The cable protector of claim 1, wherein the at least one snap-fit connection includes at least one protrusion that is insertable in at least one recess.

6. The cable protector of claim 5, wherein the at least one protrusion is carried by the lid and the at least one recess is carried by the base member.

7. The cable protector of claim 5, wherein the at least one protrusion and at least one recess are arranged coaxially with each other along a side edge of the lid.

8. The cable protector of claim 5, wherein the at least one protrusion includes a plurality of protrusions carried by a plurality of lid hinge members and the at least one recess includes a plurality of recesses carried by a plurality of base hinge members.

9. The cable protector of claim 8, wherein the plurality of lid hinge members and the plurality of base hinge members deflect to permit the plurality of protrusions to move into and out of the plurality of recesses.

10. The cable protector of claim 9, wherein at least some of the base hinge members include a recess in opposing end surfaces thereof, and at least some of the lid hinge members include a protrusion in opposing end surfaces thereof.

11. A cable protector, comprising:
a base member having first and second sides and first and second ends;
at least one channel extending between the first and second ends of the base member and structured to receive at least one cable;
a first side ramp extending from the first side of the base member;
a second side ramp extending from the second side of the base member;
at least one connector extending from the first end of the cable protector;
at least one connector recess positioned at the second end of the cable protector;
a lid mounted to the base member and movable between a closed position and an open position to control access to the at least one channel, the lid being secured to the base member with a snap-fit connection.

12. The cable protector of claim 11, wherein the snap-fit connection provides a pivotal connection of the lid to the base member.

13. The cable protector of claim 11, wherein the snap-fit connection is releasable to provide disconnection of the lid from the base member.

14. The cable protector of claim 11, wherein the lid is pivotally connected to the base member with a hinge member that is separate from the snap-fit connection.

15. The cable protector of claim 11, wherein the lid includes a plurality of protrusions and the base member includes a plurality of recesses receptive of the plurality of protrusions to provide the snap-fit connection.

16. A method of assembling a cable protector, comprising:
providing a cable protector having a base member and a lid, the base member including a plurality of channels sized to hold at least one cable;
connecting the lid to the base member with at least one releasable snap-fit connection, the lid being pivotable relative to the base member to control access to the plurality of channels.

17. The method of claim 16, wherein the lid includes a plurality of protrusions and the base member includes a plurality of recesses, and connecting the lid to the base member includes inserting the plurality of protrusions into the plurality of recesses to provide the at least one releasable snap-fit connection.

18. The method of claim 16, further comprising pivotally connecting the lid to the base member with a removable axle along a first side edge of the lid, and the at least one releasable snap-fit connection is provided along a second side edge of the lid.

19. The method of claim 16, wherein the at least one releasable snap-fit connection provides a pivotal connection between the lid and the base member.

20. The method of claim 16, wherein the at least one releasable snap-fit connection includes at least a first releasable snap-fit connection along a first side edge of the lid and at least a second releasable second snap-fit connection along a second side edge of the lid.
